(19) United States
(12) Patent Application Publication
(10) Pub. No.: US 2002/0147656 A1
(43) Pub. Date: Oct. 10, 2002

(54) E-commerce using a catalog

(76) Inventors: Richard K. Tam, Monte Sereno, CA (US); Mark A. Resmer, Campbell, CA (US)

Correspondence Address: SKJERVEN MORRILL LLP, 25 METRO DRIVE, SUITE 700, SAN JOSE, CA, 95110, US

(21) Appl. No.: 09/826,744

(22) Filed: Apr. 4, 2001

(51) Int. Cl. G06F 17/60

(52) U.S. Cl. 705/26

(57) ABSTRACT

Sellers send information on to-be-sold items (products or services) to an entity (“aggregator”) that compiles the information into an online or offline catalog for distribution to buyers. The buyers purchase the items by sending orders and payments to a financial institution (“clearinghouse”) that sends a portion of the payments to the aggregator for generating the sales and another portion to the seller for sale of their item. The clearinghouse also sends the order to the seller, or a fulfiller retained by the seller, to deliver the sold item to the buyer.

### CROSS-REFERENCE TO RELATED APPLICATIONS

This application is related to and incorporates by reference herein the commonly owned co-pending U.S. patent application Ser. No. ______, entitled “E-COMMERCE USING AN IDENTIFIER,” inventors Tam et al., filed ______, attorney docket number M-9127 US, U.S. patent application Ser. No. ______, entitled “DATA STRUCTURE FOR HOLDING PRODUCT INFORMATION,” inventors Tam et al., filed ______, attorney docket number M-9128 US, and U.S. patent application Ser. No. 09/536,192, entitled “REPOSITORY FOR PUBLISHING CONTENT IN DIFFERENT FORMS,” inventors Tam et al., filed Mar. 17, 2000.

### BACKGROUND

Electronic commerce, or e-commerce, includes maintaining business relationships and selling information, services, and commodities by means of computer telecommunications networks. Although in the vernacular e-commerce usually refers only to the trading of goods and services over the Internet, broader economic activity is included. E-commerce includes business-to-consumer and business-to-business commerce as well as internal organizational transactions that support these activities.

E-commerce originated in a standard for the exchange of business documents, such as orders or invoices, between suppliers and their business customers. This standard had its inception in the 1948-49 Berlin blockade and airlift. The U.S. Army quickly discovered that the normal manner of transacting business—accompanied by paper orders—could not keep up with the necessary flow of goods into Berlin. In order to break the paper bottleneck, Edward A. Guilbert, a logistics officer in the army, set up a system of ordering via telex, radio-teletype, and telephone. Various industries elaborated upon this system in the ensuing decades before the first general standard was published in 1975. The resulting national electronic data interchange (EDI) standard is unambiguous, independent of any particular machine, and flexible enough to handle most simple electronic transactions.

With the introduction of the first graphical “browser” software for accessing the World Wide Web in 1993, and the ensuing scramble for companies and individuals to get “online”, most e-commerce shifted to the Internet. In some fields new Internet retailers such as the bookseller Amazon.com grew up, seemingly overnight, to challenge the dominance of traditional retailers. Some established companies embraced the electronic commerce model as well. The Intel Corporation, for instance, had sold almost half of its $30 billion in annual computer chip sales directly through its Web site by 1999 and planned to move all of its sales to the Web by the end of 2000.

As important as standard forms are for business-to-business transactions, e-commerce encompasses much wider activity. For example, secure electronic transfer of sensitive information (such as credit card numbers and electronic funds transfer (EFT) orders) is essential to the continued growth of e-commerce. In addition to encrypting Web purchase forms, many individuals also routinely encrypt their e-mail.

Among other innovations that have contributed to the growth of e-commerce are electronic directories and search engines for finding information on the Web; software agents, or “bots”, that act autonomously to locate goods and services; and digital authentication services that vouch for identities over the Internet. These intermediary services facilitate the sale of goods (actually delivering the goods in the case of information), the provision of services such as banking, ticket reservations, and stock market transactions, and even the delivery of remote education and entertainment. Electronic auctions and reverse markets (where a buyer elicits offers from many sellers) are another growing component of e-commerce. From its founding in 1995, the world's largest online open auction site, eBay, grew to more than 5 million members by 1999.

Several important phenomena are associated with e-commerce. The role of geographic distance in forming business relationships is reduced. Barriers to entry into the retail business are lower, as it is relatively inexpensive to start a retail Web site. Some traditional business intermediaries are being replaced by their electronic equivalents or are being made entirely dispensable. For instance, as airlines have published fare information and enabled ticketing directly over the Internet, store-front travel agencies have declined. Prices of commodity products are generally lower on the Web—a reflection not merely of the lower costs of doing electronic business but also of the ease of comparison shopping in cyberspace. A new form of corporate cooperation known as a virtual company, which is actually a network of firms, each performing some of the processes needed to manufacture a product or deliver a service, has flourished. For more details on e-commerce, please see an article entitled “Electronic Commerce” from Encyclopedia Britannica available from the Internet.

### SUMMARY

In accordance with the invention, buyers purchase items (products and/or services) by sending orders and payments (hereafter “sales payments”) to a financial institution (hereafter “clearinghouse”). The clearinghouse sends a portion of the sales payments (hereafter “sales proceeds”) to the sellers for the sales of their products. In one embodiment, the clearinghouse sends the orders to the sellers so the sellers can deliver the products to the buyers. In another embodiment, the clearinghouse sends the orders and yet another portion of the sales payments (hereafter “shipping fees”) to entities (hereafter “fulfillers”) retained by the sellers to, inter alia, deliver the products to the buyers. The clearinghouse tracks buyer purchases from the catalog to calculate discounts provided by the sellers. In one embodiment, the clearinghouse tracks cross-promotional discounts between sellers when buyers purchase products from two or more sellers. In another embodiment, clearinghouse tracks buyer referral discounts (also known as preferred customer discounts) when buyers purchase products from the catalog on the referral of other buyers.

Depending on the embodiment, the sellers may directly transmit to buyers information (such as product information and business rules) necessary to form a sales contract. Alternatively, the sellers may provide such information in a global database maintained by another entity (hereinafter “aggregator”). In one embodiment, the aggregator compiles the descriptive information into a catalog that is distributed to buyers in any manner. For example, the aggregator delivers the catalog in tangible form such as a paper catalog, or in intangible form such as an online electronic catalog on web pages or an offline electronic catalog stored on a computer readable medium (e.g., floppy disks, compact disks (CD), and digital versatile disks (DVD)). In another embodiment, the aggregator compiles the descriptive information into presentations such as television or radio programs that promote the products from the sellers. When present, the clearinghouse sends a portion of the sales payments (hereafter “marketing fees”) to the aggregator for compiling and distributing the descriptive information of the products.

### BRIEF DESCRIPTION OF THE DRAWINGS

FIGS. 1 and 2 illustrate, in block diagrams, e-commerce systems in accordance with different aspects of the present invention.

FIG. 3 illustrates, in block diagrams, a computer network implementing the e-commerce systems of FIGS. 1 and 2.

FIG. 4 illustrates, in a flow chart, a method of a seller of FIGS. 1 and 2.

FIGS. 5 and 6 illustrate, in flow charts, a method of an aggregator of FIGS. 1 and 2.

FIG. 7 illustrates, in a flow chart, a method of a clearinghouse of FIGS. 1 and 2.

FIG. 8 illustrates, in a flow chart, a method of a fulfiller of FIG. 2.

FIG. 9 illustrates, in a flow chart, a method of a buyer of FIGS. 1 and 2.

FIG. 10 illustrates, in a block diagrams, an e-commerce system in accordance with another aspect of the present invention.

FIG. 11 illustrates, in a block diagram, a network of multiple sellers and aggregators of FIGS. 1 and 2.

### DETAILED DESCRIPTION

Traditionally, a retailer (such as Safeway® or Mailboxes etc.®) aggregates information on items (products and/or services), and business rules (that govern sales of the items) from multiple sellers, consummates financial transactions with buyers for purchase of the items, and fulfills the purchases (by physically handing over the products or by performing the services). These tasks are now segregated among multiple entities in one embodiment of the invention.

In one embodiment of the invention, an e-commerce system includes an entity (hereafter “aggregator”) that acts as a central source to which sellers (including, e.g. competitors) submit their product information and business rules for distribution to buyers. The aggregator compiles the product information and the business rules into a catalog that is distributed to buyers in any manner (e.g., paper or electronic, online or offline). Alternatively, the aggregator compiles the production information and the business rules into a radio or television program that promotes the products from the sellers. The buyers send their orders and payments to a financial institution (hereafter “clearinghouse”). A clearinghouse is, for example, a bank, a credit card company, or a lending institution. The clearinghouse sends the orders to the sellers or the entities (hereafter “fulfillers”) retained by the sellers to, inter alia, deliver the products and/or services (or tickets thereof) to the buyers. Note that instead of sending their orders to the clearinghouse, the buyers can send their orders directly to the sellers and/or fulfillers, e.g. after transmission of payment instruction to the clearinghouse. In such a case, the seller and/or fulfiller can check with the clearinghouse to confirm payment prior to delivery of the purchased items to the buyer. The clearinghouse pays the sellers for the sales of their items, pays the aggregator for compiling and distributing the catalog, and pays the fulfillers, if any, for the delivery of the items to the buyers.

The segregation of the tasks of a retailer provides several advantages. The aggregator can maintain product information and business rules of the sellers in a central database. Alternatively, the aggregator can maintain a central database of pointers to product information and business rules of the sellers maintained in their databases. The database can be used to construct an online or offline catalog that provides a convenient shopping experience for the buyers. The catalog can be stored on a computer readable medium (e.g., a digital versatile disk) that includes the products being sold (e.g., electronic content including music, books, and movies). The buyers can comparatively shop among the sellers using the catalog, e.g. because the catalog contains offers from numerous sellers for the sale of the same item. In one example, the catalog contains offers for sale by a number of retailers (such as Sears, J.C. Penney, and Mervyn's) for the very same item, e.g. the item could be a specific pair ofjeans, such as Lee° jeans of baggy fit and 30″ waist and 30″ inseam and black color, so that the buyer can comparison shop. Each item may also be identified by, e.g. a single Universal Product Code (UPC), to ensure that the same item is being compared. Also, instead of or in addition to retailers, other sellers such as wholesalers and manufacturers may supply offers in such a catalog. So in the above-described example of the Lee® jeans, the catalog may contain the related information (and optionally business rules) from the H.D. Lee Company of Shawnee Mission, Kans., in addition to (or instead of) the retailers Sears, J.C. Penney, and Mervyn's.

The sellers can also cross-promote their products using the catalog, (e.g. by providing 10% discount for $100 purchases of Sears items). The buyers can purchase the products in the catalog by sending their orders to the clearinghouse without releasing their payment information to the sellers (and the fulfillers). The clearinghouse can track the shopping history of the buyers for discounts provided by the sellers. The shopping history of the buyer and even the identity of the buyer can be kept away from the sellers when fulfillers are directly informed by the clearinghouse to deliver the products to the buyers, without disclosing the buyers to the sellers. In such a case, the fulfiller may only provide inventory information to the seller. The clearinghouse can also track the sale history of the sellers and aggregators in order to evaluate their performance.

The above e-commerce system allows buyers to purchase products through a single trusted clearinghouse. The use of the clearinghouse frees the buyers from releasing their billing information to multiple sellers in order to buy from multiple sellers. This in turn protects buyers against theft of their billing information when they transact over unsecured channels (e.g., the Internet). This e-commerce system also allows buyers to browse for products from a variety of sellers through a single catalog which may be compiled by an aggregator (depending on the embodiment). The use of a single catalog allows buyers to search for products of interest and comparison shop the same or different products among the sellers. Product searching and comparison shopping in a single catalog also exposes smaller sellers to buyers that are normally not aware of these smaller sellers but for their inclusion in the catalog. Note that instead of a single catalog, multiple catalogs may be provided (e.g., by multiple aggregators).

This e-commerce system further allows buyers to take advantage of discounts offered by the sellers. The clearinghouse can centrally track a variety of discounts offered by the sellers as the clearinghouse receives all the orders from the buyers. Depending on the variant, the clearinghouse provides all information in orders from buyers to the aggregator, with or without the identity of buyers that placed the orders. So, use of a clearinghouse can protect each buyer's personal information, such as buying and/or browsing habits, in contrast to prior art systems that allow sellers and/or aggregators to collect and use such information.

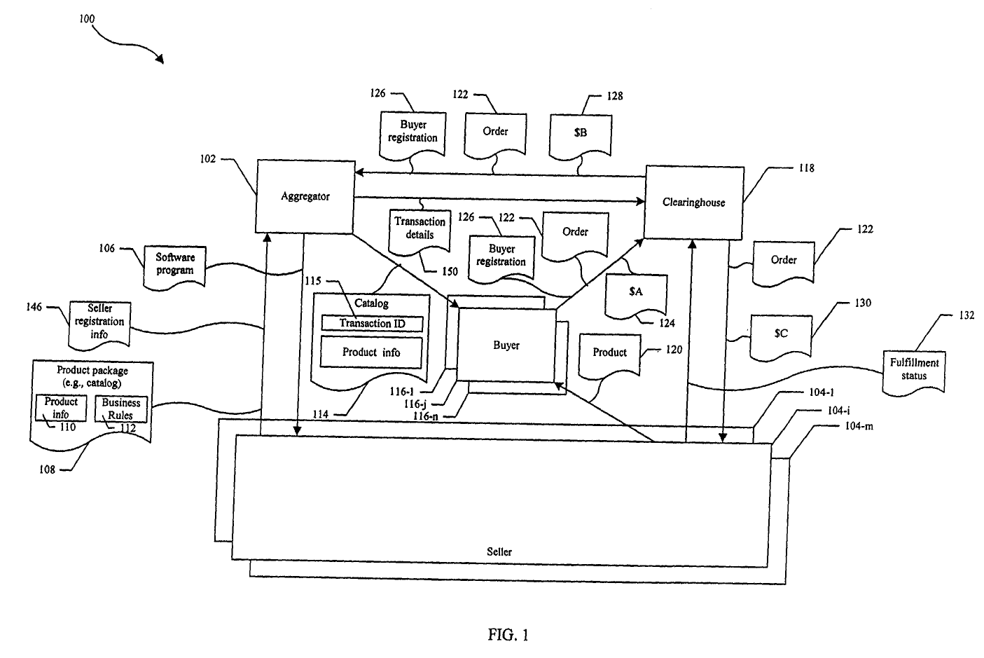

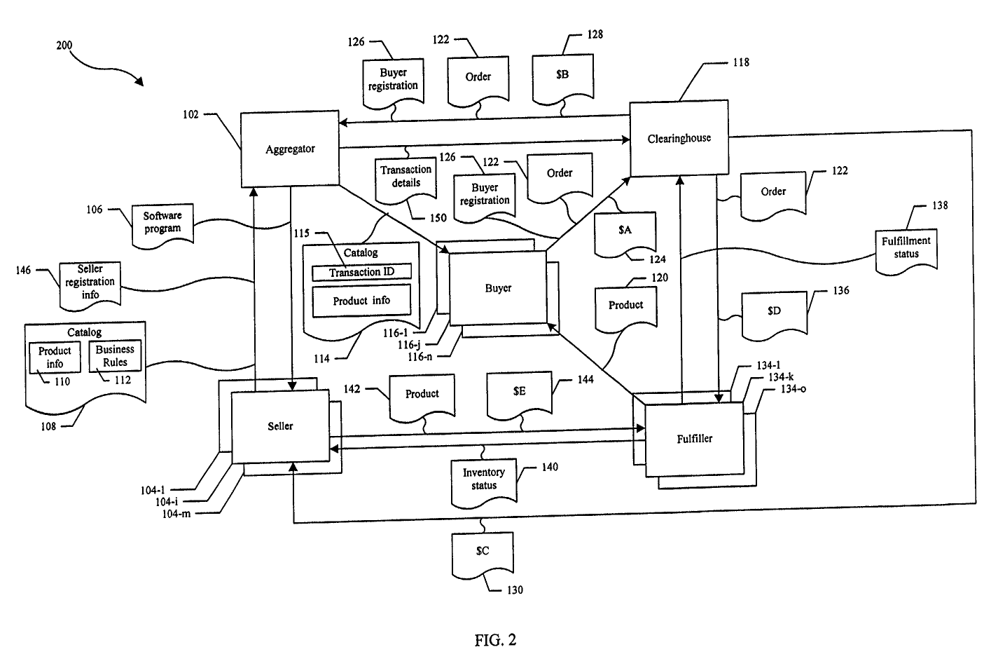

In one aspect of the invention, an e-commerce system 100 (FIG. 1) includes an aggregator 102 that sends to sellers 104-1 . . . 104-i . . . 104-m (1≦i≦m, where m is the total number of sellers in FIGS. 1 and 2) a software program 106 for authoring documents (hereafter “product packages”) of a predetermined format (e.g., XML) that include product information and business rules. A product package can be considered to be a vessel for transport of product information and business rules between sellers 104-1 to 104-m and aggregator 102. Depending on the implementation, sellers 104-1 to 104-m use utility program 106 with or without a conventional publishing software to author product packages. Conventional publishing software includes Microsoft Word and Corel WordPerfect. Sellers 104-1 to 104-m send their product packages to aggregator 102. For example, seller 104-i sends a product package 108 that includes product information 110 and business rules 112 to aggregator 102. Alternatively, sellers 104-1 to 104-m send pointers to their databases that contain the product information and business rules to aggregator 102. Sellers 104-1 to 104-m include retailers, distributors, importers, brokers, resellers, manufacturers, and other entities that sell products.

Aggregator 102 compiles the product packages from sellers 104-1 to 104-m into a catalog 114. Alternatively, aggregator 102 accesses the product information and the business rules at the databases of sellers 104-1 to 104-m and compiles the product information and the business rules into catalog 114. Aggregator 102 provides catalog 114 to buyer 116-1 . . . 116-j . . . 116-n (1≦j≦n, where n is the total number of buyers in FIGS. 1 and 2) in paper and electronic forms. For example, aggregator 102 sends catalog 114 to buyer 116-j. Authoring of product packages and compiling of the catalog are further described in related U.S. patent application Ser. No. ______, entitled “DATA STRUCTURE FOR HOLDING PRODUCT INFORMATION”, inventors Tam et al., filed ______, attorney docket number M-9128 US.

Buyers 116-1 to 116-n purchase products from catalog 114 by sending their orders and payments (hereafter “sales payments”) instructions to clearinghouse 118. For example, buyer 116j purchases a product 120 from seller 104-i by sending an order 122 and payment instructions 124 ($A) to clearinghouse 118. In one embodiment, buyers 116-1 to 116-n register with clearinghouse 118 so they do not need to provide their billing and shipping information more than once. For example, buyer 116-j sends buyer registration information 126 to clearinghouse 118 to register with clearinghouse 118. Buyer registration information 126 includes, for example, buyer name, address, billing information, interests, age, income level, a personal identification number (e.g., a password), and other conventional characteristics used to profile a buyer for marketing purposes. In one implementation, clearinghouse 118 reduces sales payment 124 for product 120 if buyer 116-j qualifies for a discount provided by sellers 104-i in business rules 112 of product packages 108. A business rule may provide a discount, e.g., if the buyer permits release of his or her identity to the seller.

In one embodiment, clearinghouse 118 sends registration information of buyers 116-1 to 116-n to aggregator 102. For example, clearinghouse 118 sends buyer registration 126 to aggregator 102. In these embodiments, aggregator 102 uses buyer registration information to compile catalogs targeted toward specific buyers. For example, aggregator 102 compiles a catalog of camping equipment for buyers that are interested in camping. In some implementations, aggregator 102 uses buyer registration information to compile a catalog that includes strings of characters or numbers (hereafter “transaction identifiers”) used to identify a transaction that can happen between a buyer and seller. For example, aggregator 102 includes a transaction identifier 115 that identifies all information related to a possible sale of product 120 (e.g., a tent) that can happen between seller 104-i (e.g., a tent manufacturer or retailer) and buyer 116-j (e.g., a camping enthusiast). In one embodiment, aggregator 102 maintains the information in a database and distributes the transaction identifier with a product's description. Transaction identifiers are further described in related U.S. patent application Ser. No. ______, entitled “E-COMMERCE USING AN IDENTIFIER”, inventors Tam et al., filed ______, attorney docket number M-9127 US.

In such implementations, clearinghouse 118 queries aggregator 102 with the transaction identifiers to receive transaction details including buyer information (e.g., buyer name and shipping address), seller information (e.g., seller name and contact information), fulfiller information (e.g., fulfiller name and contact information), if any, and product information (e.g., product number). For example, clearinghouse 118 queries aggregator 102 with transaction identifier 115 to receive transaction detail 150. In an alternative embodiment, clearinghouse 118 maintains the above-described database of information on potential sales, and distributes the transaction identifiers to sellers and buyers.

In one implementation, clearinghouse 118 sends payments (hereafter “marketing fees”) to aggregator 102 for compiling and distributing the catalogs that generated the orders received by clearinghouse 118. For example, clearinghouse 118 sends marketing fees instructions 128 ($B) to aggregator 102 as payment for compiling and distributing catalog 114 that generated the sale of product 120. Marketing fees can be a fixed payment or a percentage of the sale price of the item. Aggregator 102 can set the marketing fees. Alternatively, sellers 104-1 to 104-m can set the marketing fees in business rule 112.

Clearinghouse 118 also sends payments (hereafter “sales proceeds”) to sellers 104-1 to 104-m for the sales of their products. For example, clearinghouse 118 sends sales proceeds instructions 130 ($C) to seller 104-i for the sale of product 120. Clearinghouse 118 further sends the orders to sellers 104-1 to 104-m so they can fulfill the orders for buyers 116-1 to 116-n. For example, clearinghouse 118 sends order 122 to seller 104-i.

In another implementation, clearinghouse 118 pays the sales payments to aggregator 102 and aggregator 102 pays the sales proceeds to sellers 104-1 to 104-m. Sales proceeds generally consists a majority of the sales payment. In yet another implementation, clearinghouse 118 pays the sales payments to sellers 104-1 to 104-m and the sellers 104-1 to 104-m pays the marketing fees to aggregator 102.

In one embodiment, sellers 104-1 to 104-m send fulfillment status reports to clearinghouse 118. For example, seller 104-i sends a fulfillment status report 132 to clearinghouse 118 after seller 104-i ships product 120 to buyer 116-j. In one implementation, clearinghouse 118 pays sellers 104-1 to 104-m only when sellers 104-1 to 104-m confirm shipment of the products to, or receipt of the products by, buyers 116-1 to 116-n with fulfillment status reports. The fulfillment status report of one embodiment identifies the products delivered, the recipient's name and address, and date of delivery.

In another aspect of the invention, an e-commerce system 200 (FIG. 2) includes a clearinghouse 118 that sends orders to fulfillers 134-1 . . . 134-k . . . 134-o (1≦k≦o, where o is the total number of fulfillers in FIG. 2) instead of seller 1041 to 104-m. For example, clearinghouse 118 sends order 122 to fulfiller 134-k. Sellers 104-1 to 104-m use fulfillers 134-1 to 134-o to, for example, warehouse, sell, and/or deliver products to buyers 114-1 to 114-n. Fulfillers 134-1 to 134-o include logistic service providers, retailers, resellers, and distributors. Fulfillers 134-1 to 134-o deliver products to buyers 116-1 to 116-n when they receive the orders from clearinghouse 118. For example, fulfiller 134-k delivers product 120 to buyer 116-j after fulfiller 134-k receives order 122 from clearinghouse 118. Alternatively, fulfillers 134-1 to 134-o make the products available for pickup by buyers 116-1 to 116-n at predetermined locations. In one embodiment, clearinghouse 118 sends payments (hereafter “shipping fees”) to fulfillers 134-1 to 134-o for delivering the products to buyers 116-1 to 116-n. For example, clearinghouse 118 sends a shipping fees 136 ($D) to fulfiller 134-k for delivery of product 120 to buyer 116-j.

In one embodiment, fulfillers 134-1 to 134-0 send fulfillment status reports to clearinghouse 118. For example, fulfiller 134-k sends a fulfillment status report 138 to clearinghouse 118 after fulfiller 134-k ships product 120 to buyer 116-j. In one implementation, clearinghouse 118 pays sellers 104-1 to 104-m only when fulfillers 1341 to 134-o confirm shipment of the products to, or receipt of the products by, buyers 1161 to 116-n with fulfillment status reports.

In one embodiment, fulfillers 134-1 to 134-o send inventory status reports to sellers 104-1 to 104-m. For example, fulfiller 134-k sends an inventory status report 140 to seller 104-i. If the inventory is low or if new products become available, sellers 104-1 to 104-m send their products to fulfillers 134-1 to 134-o to maintain a sufficient inventory to meet demands from buyers 116-1 to 116-n. For example, seller 104-i sends a new product 142 to fulfiller 134-k. In one embodiment, sellers 104-1 to 104-m also send payments (hereafter “warehousing fees”) to fulfillers 134-1 to 134-o for warehousing the products. For example, seller 104-i sends a warehousing fees 144 ($E) to fulfiller 134-k for warehousing its products. In one embodiment, aggregator 102, seller 104-i, buyer 116-j, clearinghouse 118, and fulfiller 134-k are business entities (e.g., corporation, partnerships, and persons) independent from each other. As used herein, business entities are independent from each other if they make business decisions free of financial consideration for each other. Business entities are also independent from each other if they make business decisions independent of each other.

In one embodiment, seller 104-i is a manufacturer of a product that is sold through fulfillers 134-1 to 134-o. Fulfillers 134-1 to 134-o are, e.g., distributors, retailers, and/or resellers of the product from seller 104-i. In this embodiment, seller 104i includes in product package 108 the identifications of fulfillers 134-1 to 134-o, their ordering information (e.g., order telephone line, mailing address, or web address), and terms and conditions (e.g., prices of the product and various discounts available from each of the fulfillers). In this embodiment, catalog 114 includes listings of the same product available at different terms and conditions from various fulfillers. Buyer 116j chooses among the fulfillers for the best deal. Once buyer 116-j has selected to purchase the product from a particular fulfiller, buyer 116-j sends the order and sales payment to clearinghouse 118 and clearinghouse 118 sends the order to the appropriate fulfiller.

In another embodiment, sellers 104-1 to 104-m are sellers that sell the same product from a manufacturer. Sellers 104-1 to 104-m submit product packages 108 to aggregator 102 so their terms and conditions are listed in catalog 114. Once buyer 116-j selects to purchase the product from one of sellers 104-1 to 104-m, buyer 116-j sends the order and sales payment to clearinghouse 118 and clearinghouse 118 sends the order to the appropriate seller or its fulfiller, if any.

In one example of this embodiment, two or more sellers offer the same item under a common set of terms and conditions and these terms and conditions are displayed commonly in a single area (e.g. top portion of a computer screen), followed by a list of seller names and prices (one seller and price per line in a bottom portion of the screen), thereby to allow the buyer to comparison shop based on price. Instead of price, other parameters may be used to comparison shop, e.g. delivery date.

In one embodiment, catalog 114 contains specific terms that define an “offer for sale” of a number of items, thereby to create in a specific buyer 116-j (to whom the catalog 114 has been targeted) the power of acceptance. In this specific embodiment, these descriptions are not advertisements because they are not too vague regarding quantity, duration, etc. Instead of, or in addition to, such “offers for sale”, catalog 114 may contain advertisements (that are not offers to sell), in which case the buyer 116-j creates an offer to buy (based on the information and business rules in catalog 114), which is accepted by a specific seller 104-i to whom the offer is directed.

As the aspects of the invention described above involve the interaction of multiple parties, the actions of each party will be described individually with reference to FIGS. 1 and 2.

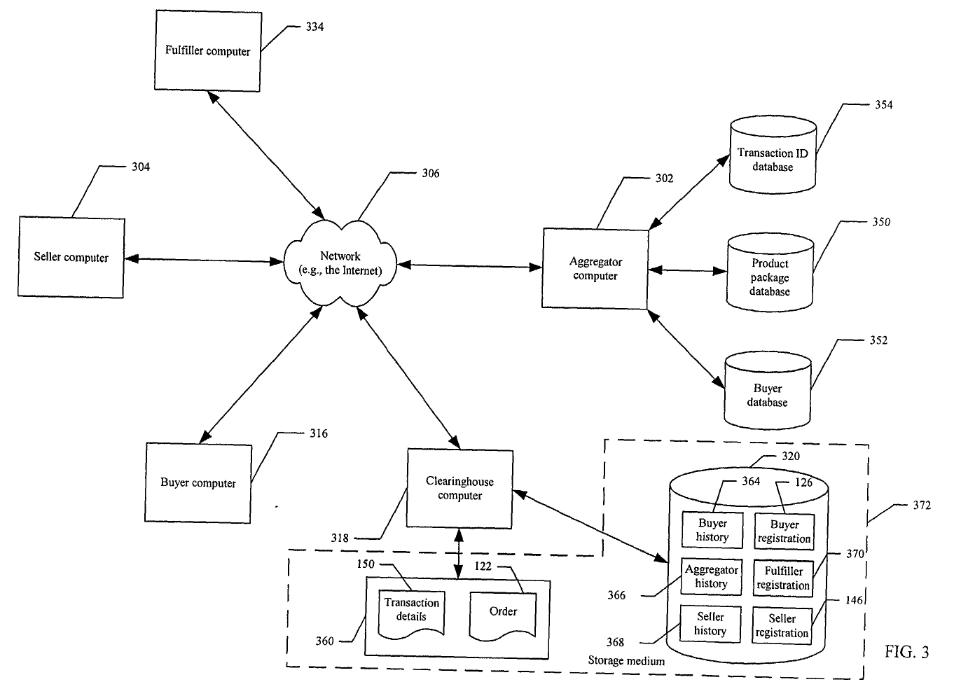

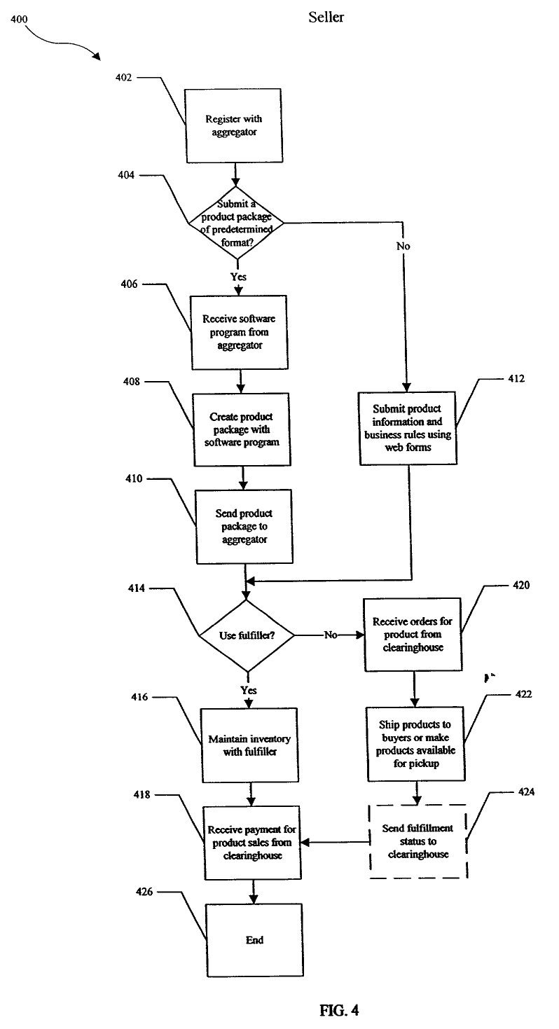

Method 400 (FIG. 4) illustrates the actions of seller 104-i in one embodiment. In one implementation, seller 104-i uses a seller computer 304 (FIG. 3) to transact with an aggregator computer 302 (FIG. 3) used by aggregator 102 over a network 306 (FIG. 3) such as the Internet. Communication over network 306 can occur through land lines or wireless connections.

In action 402 (FIG. 4), seller 104-i registers with aggregator 102. In one implementation, seller 104-i uses a conventional web browser on seller computer 304 to send seller register information 146 (FIGS. 1 and 2) via web forms to aggregator computer 302 over network 306. Conventional web browser includes Microsoft Explorer and Netscape Navigator. Web forms are web pages where information can be provided via text boxes, check boxes, and drop-down lists. Seller registration information 146 includes the seller's contact information (e.g., address and telephone number), billing information (e.g., bank account number), methods by which orders can be submitted to the seller (e.g., order telephone line, order address line, order web address, order email address, and electronic data interchange (EDI) information), geographical restriction of sales, and special shipping and handling instructions. In another implementation, seller 104-i uses seller computer 304 to send seller registration information 146 as part of product package 108 (described later in actions 406, 408, and 410) to aggregator computer 302.

Seller 104-i can also register with clearinghouse 118 by sending seller registration information 146 to clearinghouse computer 318. Clearinghouse computer 318 saves seller register information 146 in database 320. Clearinghouse 118 can use seller registration information to determine how to pay and send orders to seller 104-i.

In action 404, seller 104-i determines whether or not to submit product information and business rules to aggregator 102 in a product package of a predetermined format (e.g., as an XML document) accepted by aggregator 102. If seller 104-i decides to submit product information and business rules in a product package, action 404 is followed by action 406. Otherwise, action 404 is followed by action 412.

In action 406, seller 104-i receives software program 106 from aggregator 102. In one implementation, seller 104-i uses seller computer 304 to receive program 106 from aggregator computer 302 via network 306 in the normal manners (e.g., using HTTP or FTP).

In action 408, seller 104-i creates product package 108. Depending on the implementation, seller 104-i uses program 106 with or without conventional publishing software on seller computer 304 to create product package 108. In some variations, product package 108 is an XML document where individual product information 110 (e.g., name, product number, related product number(s), price, description, specification, image, search category, keywords, sales conditions, fulfillment method, and fulfiller identities) and business rules 112 (e.g., discounts) are identified by XML tags. Alternatively, product package 108 includes pointers to a database containing product information 110 and business rules 112. Product package 108 can also include the items for sales (e.g., electronic content including music, books, and movies).

In action 410, seller 104-i sends product package 108 to aggregator 102. In one implementation, seller 104-i uses seller computer 304 to send product package 108 to aggregator computer 302 via network 306 in the normal manners. In another implementation, seller 104-i sends a computer readable medium with product package 108 saved thereon to aggregator 102 via a common carrier (e.g., US Postal Service, UPS, FedEx, and DHL). Computer readable medium includes floppy disks, compact disks, flash memory, compact disks, digital versatile disks, and other computer storage mediums. Action 410 is followed by action 414.

Embodiments of actions 406, 408, and 410 are further described in related U.S. patent application Ser. No. ______, entitled “DATA STRUCTURE FOR HOLDING PRODUCT INFORMATION”, inventors Tam et al., filed ______, attorney docket number M-9128 US.

In action 412, seller 104-i uses the conventional web browser on seller computer 304 to submit product information 110 and business rules 112 via web forms from aggregator computer 302 over network 306. Alternatively, seller 104-i submits pointers to a database containing production information 110 and business rules 112 via web forms. Seller 104-i can also send items for sale (e.g., electronic content including music, books, and movies) to aggregator computer 302 over network 306. Action 412 is followed by action 414.

Action 414 is a decisional state. If seller 104-i retains the services of fulfiller 134k to warehouse and deliver products to buyers 116-1 to 116-n, action 414 is followed by action 416. Otherwise, action 414 is followed by action 420.

In action 416, seller 104-i maintains an inventory of products with fulfiller 134-k. In one implementation, seller 104-i optionally receives inventory status report 140 from fulfiller 134-k so that seller 104-i can ensure that product inventory meets the demands of buyers 116-1 to 116-n. Inventory status report 140 includes the number of each product currently available through fulfiller 134-k, delivery time of products, sales trend, and lead time to restock and/or manufacture the products. In some variations, seller 104-i uses seller computer 304 to receive inventory status report 140 from a fulfiller computer 334 (FIG. 3) via network 306 in the normal manners. In some examples, seller computer 304 and fulfiller computer 334 communicate inventory status report 140 through customized or industry standard EDI (including XML). For a description of industry standard EDI such as XML, see an article entitled “Understanding ebXML, UDDI and XML/edi” by David Webber and Anthony Dutton available from XML.ORG at its web site, which is hereby incorporated by reference in its entirety.

In action 418, seller 104-i receives sales proceeds for products ordered by buyers 116-1 to 116-n from clearinghouse 118. For example, seller 104-i receives sales proceeds 130 ($C) from clearinghouse 118 for product 120 ordered by buyer 116-j. In one implementation, clearinghouse 118 uses clearinghouse computer 318 to electronically transfer at least a portion of the sales payments received from buyers 116-1 to 116-n to an account of seller 104-i. For example, clearinghouse 118 transfers sales proceeds 130 ($C) from sales payment 124 ($A, where A≧C) received from buyer 116-j to an account of seller 104-i. Action 418 is followed by action 426, which ends method 400.

In action 420, seller 104-i receives from clearinghouse 108 orders for products from buyers 116-1 to 116-n. In one implementation, seller 104-i uses seller computer 304 to receive order 122 for product 120 from clearinghouse computer 318 over network 306 in the normal manners. Order 122 includes a product number (e.g., a stock number or an UPC number) and fulfillment instructions (e.g., delivery to a shipping address or pickup at a predetermined location). In other variations where order 122 simply includes transaction identifier 115, seller 104-i uses seller computer 304 to receive from clearinghouse computer 308 transaction details 150 (described later in action 708) that include a product number and fulfillment instructions. In some variations, seller computer 304 and clearinghouse computer 318 communicate order 122 and transaction details 150 through customized or industry standard EDI (including XML).

In action 422, seller 104-i fulfills the orders from buyers 116-1 to 116-n. Depending on the fulfillment methods available from each seller and the fulfillment instructions from each buyer, seller 104-i can deliver the products or make the products available for pickup. Depending on the implementation, seller 104-i can deliver the ordered products itself or use a common carrier to deliver the products. In one variation, seller 104-i fulfills the order by sending product 120 (e.g., electronic content such as music, books, and movies) to a buyer over network 306. In the variation where product 120 (e.g., electronic content) and catalog 114 are both stored on a computer readable medium (e.g., digital versatile disk) distributed to the buyers, seller 104-i can fulfill the order by sending a key to buyer 116-j for accessing product 120 from the computer readable medium.

In action 424, seller 104-i optionally sends a fulfillment status report to clearinghouse 118 as in one implementation, clearinghouse 118 only pays the seller once the seller has shipped the ordered product. In some variations, seller 104-i uses seller computer 304 to send fulfillment status report 132 to clearinghouse computer 318 in the normal manners. Fulfillment status report includes an order number, a shipping date, a shipping tracking number, a shipper identification, and other custom information that may be requested by a particular clearinghouse. In some variations, seller computer 304 and clearinghouse computer 318 communicate fulfillment status report 132 through customized or industry standard EDI (including XML).

Action 424 is followed by action 418, in which seller 104-i receives from clearinghouse 118 sales proceeds for products ordered by buyers 116-1 to 116-n. As previously described, action 424 is followed by action 426, which ends method 400. Although only a single seller computer 304 is shown, one skilled in the art understands that multiple seller computers can be used by sellers 104-1 to 104-m as described in method 400.

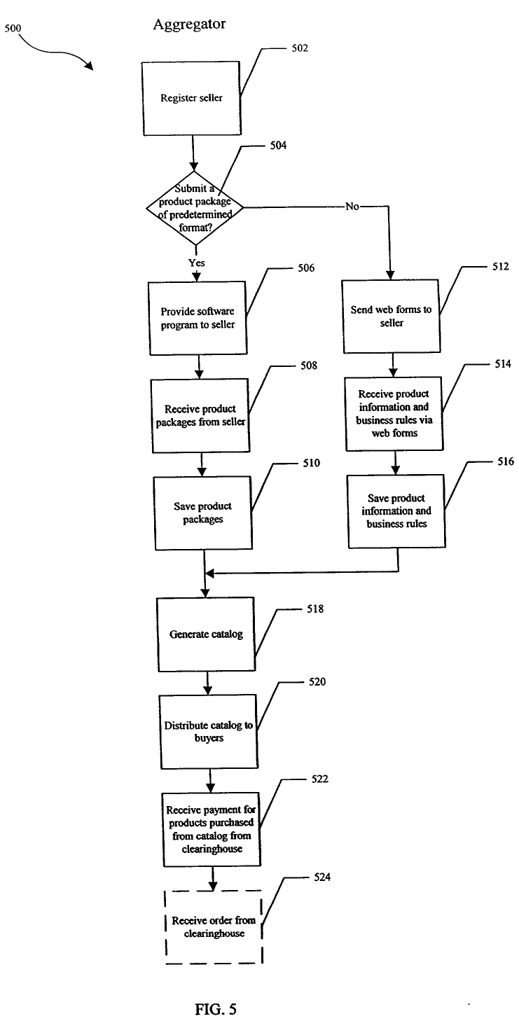

Method 500 (FIG. 5) illustrates the actions of aggregator 102 in one embodiment. In one implementation, aggregator 102 uses aggregator computer 302 (FIG. 3) to transact with seller computer 304 and clearinghouse computer 318 over network 306. Communication over network 306 can occur through land lines or wireless connections.

In action 502, aggregator 102 registers seller 104-i. In one implementation, aggregator 102 uses aggregator computer 302 to receive seller registration information 146 via web forms from seller computer 304 over network 306 in the normal manners. In another implementation, aggregator 102 uses aggregator computer 302 to receive seller registration information 146 via product package 108 from seller computer 304 over network 306 (described later in action 508). Action 502 corresponds to action 402 of method 400.

In action 504, aggregator 102 determines if seller 104-i wishes to submit product information and business rules for its products in a product package. If so, action 504 is followed by action 506. Otherwise, action 504 is followed by action 512.

In action 506, aggregator 102 sends program 106 to seller 104-i. In one implementation, aggregator 102 uses aggregator computer 302 to send program 106 to seller computer 304 via network 306 in the normal manners. In another implementation, aggregator 102 sends program 106 on a computer readable medium to seller 104-i via a common carrier.

In action 508, aggregator 102 receives product package 108 from seller 104-i. In one implementation, aggregator 102 uses aggregator computer 302 to receive product package 108 from seller computer 304 via network 306 in the normal manners. In another implementation, aggregator 102 receives product package 108 on a computer readable medium from seller 104-i via a common carrier. As described above, product package 108 can include the product for sale. Action 508 corresponds to action 410 of method 400.

In action 510, aggregator 102 saves product package 108. In one implementation, aggregator 102 uses aggregator computer 302 to save product package 108 in a product package database 350 (FIG. 3). In some variations, aggregator computer saves the XML tags and the data identified by the XML tags as described in related U.S. patent application Ser. No. 09/536,192, entitled “REPOSITORY FOR PUBLISHING CONTENT IN DIFFERENT FORMS”, inventors Tam et al., filed Mar. 17, 2000, attorney docket number M-8393 US. In other variations, aggregator computer 302 saves each product entry of product package 108 as an individual entry in database 350.

In one implementation, aggregator computer 202 saves its identification and the date it received product package 108 in business rule 112 in database 350. Aggregator 102 can distribute product package 108 to other aggregators so products in product package 108 can be included in catalogs created by other aggregators. When a product is sold through a catalog generated by another aggregator, the identification of aggregator computer 202 in business rule 112 allows seller 104-i to compensate aggregator 102. Seller 104-i can instruct clearinghouse 118 to pay all the aggregators recorded in business rule 112. The compensation of aggregator 102 encourages the distribution of product packages 108 to other aggregators, thereby increasing the number of catalogs that include the products of seller 104-i. For further details, see related U.S. patent application Ser. No. ______, entitled “DATA STRUCTURE FOR HOLDING PRODUCT INFORMATION”, inventors Tarn et al., filed ______, attorney docket number M-9128 US. Action 510 is followed by action 518.

In action 512, aggregator 102 uses aggregator computer 302 to send web forms to seller computer 304 via network 306. In these web forms, seller 104-i provides product information and business rules for its products.

In action 514, aggregator 102 uses aggregator computer 302 to receive product information and business rules of products from seller computer 304 via web forms over network 306. In one implementation, aggregator computer 302 saves the product information and business rules in an XML document where XML tags identify the individual product information and business rules. Action 514 corresponds to action 412 of method 400.

In action 516, aggregator 102 saves product information and business rules in database 350. Similar to action 510, aggregator computer 302 may save the XML tags and the data identified by the XML tags as described in related U.S. patent application Ser. No. 09/536,192, entitled “REPOSITORY FOR PUBLISHING CONTENT IN DIFFERENT FORMS”, inventors Tam et al., filed Mar. 17, 2000, attorney docket number M-8393 US. Alternatively, aggregator computer 302 may save each product entry of product package 108 as an individual entry in database 350. Action 516 is followed by action 518.

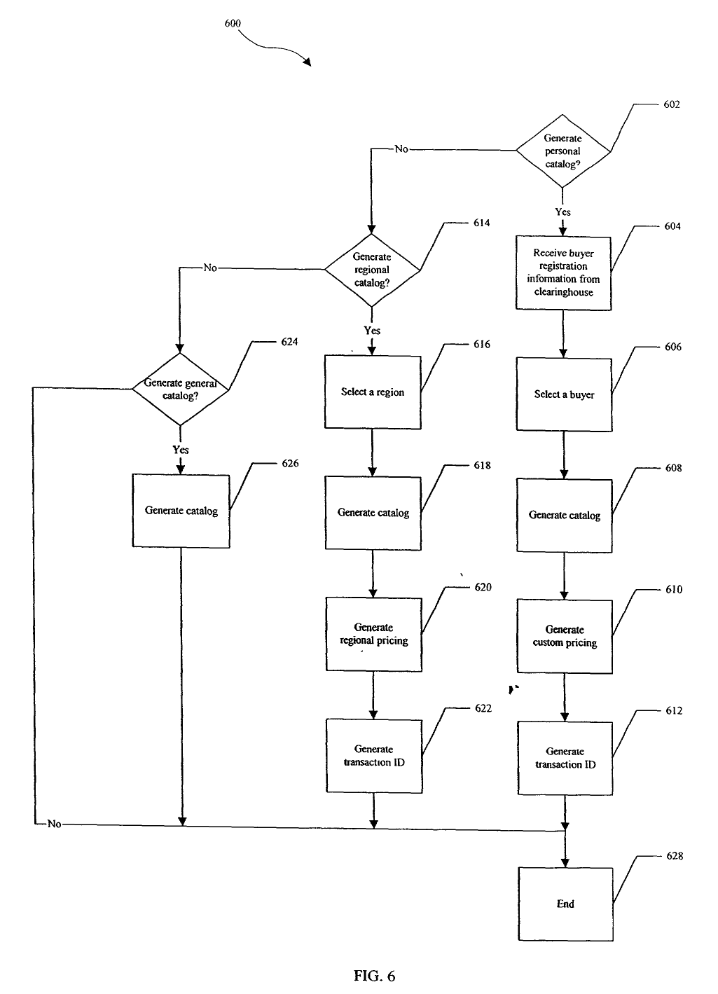

In action 518, aggregator 102 generates a catalog 114. In one implementation, aggregator 102 generates catalog 114 from only product package 108 received from seller 104-i. In another implementation, aggregator 102 generates catalog 114 from at least portions of two or more product packages submitted by sellers 104-1 to 104-m. Action 518 is later described in more detail in reference to method 600 in FIG. 6.

In action 520, aggregator 102 sends catalog 114 to buyers 116-1 to 116-n. Depending on the implementation, aggregator 102 sends catalog 114 to a specific buyer, a specific region, or to the general public and tailors catalog 114 according to the recipients (described later in reference to FIG. 6). Depending on the variation, aggregator 102 distributes catalog 114 as an online catalog via web pages, a paper catalog delivered by a common carrier, or an electronic catalog saved on a computer readable medium delivered by a common carrier. Embodiments of action 518 and 520 are further described in related U.S. patent application Ser. No. ______, entitled “DATA STRUCTURE FOR HOLDING PRODUCT INFORMATION”, inventors Tam et al., filed ______, attorney docket number M-9128 US.

In action 522, aggregator 102 receives marketing fees from clearinghouse 118 for sales generated from the compilation and distribution of catalog 114 (described later). For example, aggregator 102 receives marketing fees 128 ($B) from clearinghouse 118. In one implementation, clearinghouse 118 uses clearinghouse computer 318 to electronically transfer at least a portion of the sales payments received from buyers 116-1 to 116-n for the products to an account of aggregator 102. For example, clearinghouse 118 transfers marketing fees 128 ($B) from sales payment 124 ($A, where A≧B) received from buyer 116-j to an account of aggregator 102. Marketing fees can be a flat fee or a percentage of the sales generated from catalog 114. Alternatively, aggregator 102 may require sellers 104-1 to 104-m to pay marketing fees when they submit product information and business rules of their products.

In action 524, aggregator 102 optionally receives orders placed by buyers from clearinghouse 118 for sales generated from the compilation and distribution of catalog 114 (described later). For example, aggregator computer 302 receives a copy of order 122 from clearinghouse computer 318. In one implementation, aggregator computer 302 and clearinghouse computer 318 communicate order 122 through customized or industry standard EDI (including XML). In some variations, aggregator 102 stores buyer orders to profile the buying habits of the buyers. By profiling the buying habits of the buyers, aggregator 102 can determine the interests of the buyers to better tailor catalogs to the buyers and generate more sales. Aggregator computer 302 saves orders placed by buyers (e.g., purchase history) in buyer database 352.

Method 600 (FIG. 6) is an embodiment of action 518 of method 500. In action 602, aggregator 102 determines whether or not to generate a catalog tailored to the interests of a specific buyer. If so, action 602 is followed by action 604. Otherwise, action 602 is followed by action 614.

In action 604, aggregator 102 receives buyer registration information from clearinghouse 118. In one implementation, aggregator 102 uses aggregator computer 302 to receive buyer registration information 126 from clearinghouse computer 318. In some variations, seller computer 304 and clearinghouse computer 318 communicate buyer registration information 126 through customized or industry standard EDI (including XML).

Aggregator computer 302 saves buyer registration information 126 in a buyer database 352 (FIG. 3). Aggregator 102 later uses buyer registration information 126 to create a catalog 114 that is tailored to the interest of specific buyers.

In action 606, aggregator 102 selects a buyer (e.g., buyer 116-j) from buyer database 352. In one implementation, aggregator computer 302 selects a buyer from buyers database 352 based on a personal attribute of the buyer (e.g., interest, age, income level, and etc.). In another implementation, aggregator computer 302 selects a buyer from buyer database 352 in any logical or random order.

In action 608, aggregator 102 generates catalog 114 for buyer 116j. In one implementation, aggregator computer 302 retrieves product information and business rules of products from product package database 350 that interest buyer 116-j according to buyer registration information 126. Similarly, aggregator 102 can use buying habits of buyers received in action 524 (described above) to tailor catalog 114 to the interest of buyer 116-j. Aggregator computer 302 saves the product information and business rules in an XML document. Aggregator computer 302 then generates catalog 114 from the XML document using an extensible style language (XSL) style sheet. Aggregator computer 302 uses XSL style sheet to format the presentation of the XML document and to transform the XML document into a document in another computer language such as hypertext markup language (HTML). Embodiments of action 608 are further described in related U.S. patent application Ser. No. ______, entitled “DATA STRUCTURE FOR HOLDING PRODUCT INFORMATION”, inventors Tam et al., filed ______, attorney docket number M-9128 US. In one variation, aggregator computer 302 stores the products for sale (e.g., electronic content including music, books, and movies) and the catalog on a computer readable medium (e.g., digital versatile disk) that is distributed to the buyers.

In action 610, aggregator 102 generates custom pricing for buyer 116-j. In one implementation, aggregator computer 302 generates custom pricing according to the business rules for each product in the XML document. For example, the business rules may provide a predetermined discount percentage for buyers of a specific age. If buyer 116-j is of this specific age, aggregator computer 302 calculates a custom price for buyer 116-j according to the predetermined discount percentage. Aggregator computer 302 includes this custom price in catalog 114 generated in action 608.

In action 612, aggregator 102 generates transaction identifiers that identify sales transactions that can happen between sellers and buyer 116-j. In one implementation, aggregator computer 302 generates the transaction identifiers for the products in the XML document and saves the transaction identifiers in a transaction identifier database 354 (FIG. 3). In database 354, tables are used to reference transaction identifiers to the buyer, the seller, the fulfiller (if any), the product, the price of the product, and discounts available for the product to the buyer. Aggregator computer 302 includes the transaction identifiers in catalog 114 generated in action 608. Embodiments of action 612 are further described in related U.S. patent application Ser. No. ______, entitled “E-COMMERCE USING AN IDENTIFIER”, inventors Tam et al., filed ______, attorney docket number M-9127 US. Action 612 is followed by action 628, which ends method 600.

In action 614, aggregator 102 determines whether or not to generate a catalog tailored to a specific geographical region (e.g., western United States). If so, action 614 is followed by action 616. Otherwise, action 614 is followed by action 624.

In action 616, aggregator 102 selects a geographic region where catalogs are to be distributed. In action 618, aggregator 102 generates catalog 114 for buyer 116j. In one implementation, aggregator computer 302 retrieves product information and business rules of products from product package database 350 that interest buyers in the selected region. Aggregator computer 302 saves the product information and business rules in an XML document. Aggregator computer 302 then generates catalog 114 from the XML document using an extensible style language (XSL) style sheet. Aggregator computer 302 uses XSL style sheet to format the presentation of the XML document and to transform the XML document into a document in another computer language such as hypertext markup language (HTML). Embodiments of action 618 are further described in related U.S. patent application Ser. No. ______, entitled “DATA STRUCTURE FOR HOLDING PRODUCT INFORMATION”, inventors Tam et al., filed ______, attorney docket number M-9128 US. In one variation, aggregator computer 302 stores the products for sale (e.g., electronic content including music, books, and movies) and the catalog on a computer readable medium (e.g., digital versatile disk) distributed to the buyers.

In action 620, aggregator 102 generates custom pricing for the selected region. In one implementation, aggregator computer 302 generates custom pricing according to the business rules for each product in the XML document. For example, the business rules may provide a predetermined discount percentage for a specified region. If the selected region is the specified region, aggregator computer 302 calculates a regional price for the buyers according to the predetermined discount percentage. Aggregator computer 302 includes this regional price in catalog 114 generated in action 618.

In action 622, aggregator 102 generates transaction identifiers that identify sales transactions that can happen between sellers and the buyers of the region. In one implementation, aggregator computer 302 generates the transaction identifiers for the products in the XML document and saves the transaction identifiers in transaction identifier database 354 (FIG. 3). In database 354, tables are used to reference transaction identifiers to the seller, the fulfiller (if any), the product, the price of the product, and discounts available for the product to the buyer. Aggregator computer 302 includes the transaction identifiers in catalog 114 generated in action 618. Embodiments of action 622 are further described in related U.S. patent application Ser. No.______, entitled “E-COMMERCE USING AN IDENTIFIER”, inventors Tam et al., filed , attorney docket number M-9127 US. Action 622 is followed by action 628, which ends method 600.

In action 624, aggregator 102 determines whether or not to generate a catalog for the general public. If so, action 624 is followed by action 626. Otherwise, action 624 is followed by action 628, which ends method 600.

In action 626, aggregator 102 generates catalog 114 for the general public. In one implementation, aggregator computer 302 retrieves product information and business rules of products from product package database 350 based on any or no criteria. Aggregator computer 302 saves the product information and business rules in an XML document. Aggregator computer 302 then generates catalog 114 from the XML document using an extensible style language (XSL) style sheet. Aggregator computer 302 uses XSL style sheet to format the presentation of the XML document and to transform the XML document into a document in another computer language such as hypertext markup language (HTML). Embodiments of action 626 are further described in related U.S. patent application Ser. No. ______, entitled “DATA STRUCTURE FOR HOLDING PRODUCT INFORMATION”, inventors Tam et al., filed ______, attorney docket number M-9128 US. In one variation, aggregator computer 302 stores the products for sale (e.g., electronic content including music, books, and movies) and the catalog on a computer readable medium (e.g., digital versatile disk) distributed to the buyers. Action 626 is followed by action 628, which ends method 600.

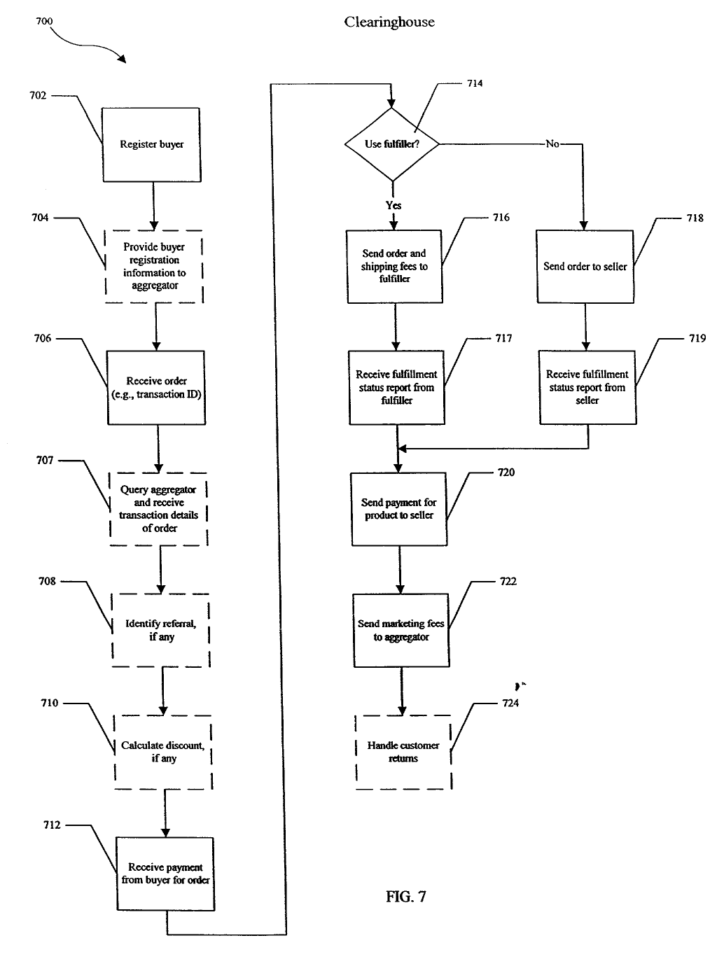

Method 700 (FIG. 7) illustrates the actions of clearinghouse 118 in one embodiment. In one implementation, clearinghouse 118 uses clearinghouse computer 318 (FIG. 3) to transact with seller computer 304, aggregator computer 302, fulfiller computer 334, and a buyer computer 316 over a network 306. Communication over network 306 can occur through land lines or wireless connections.

In action 702, clearinghouse 118 registers a buyer (e.g., buyer 116-j). In one implementation, clearinghouse 118 uses clearinghouse computer 318 to receive buyer registration information 126 via web forms from buyer computer 316 over network 306 in the normal manner. In another implementation, a service representative of clearinghouse 118 receives buyer registration information 126 via the telephone or the mail. In some variations, buyer 116-j is provided with, or selects, a password used subsequently to verify the identity of buyer 116-j. Buyer registration information 126 is then saved in database 320.

In action 704, clearinghouse 118 optionally provides buyer registration information to aggregator 102. In one implementation, clearinghouse 118 uses clearinghouse computer 318 to send buyer registration information 126 in the normal manners to aggregator computer 302 used by aggregator 102. In some variations, clearinghouse 118 obtains permission from buyers prior to sending buyer registration information to aggregator 102. In some examples, clearinghouse computer 318 and aggregator computer 302 communicate buyer registration information 126 through customized or industry standard EDI (including XML). Action 704 corresponds to action 604 of method 600.

In action 706, clearinghouse 118 receives order 122 from buyer 116-j. In one implementation, clearinghouse 118 uses clearinghouse computer 318 to receive order 122 from buyer computer 316 via network 306 in the normal manners. Clearinghouse computer 318, e.g., holds order 122 in memory 360 (or database 320). Memory 360 and database 320 are both part of a storage medium 372 of clearinghouse computer 318. In another implementation, a customer representative of clearinghouse 118 receives order 122 from buyer 116-j via the telephone or the mail. In some variations, order 122 includes transaction identifier 115 that can be referenced to a sales transaction between buyer 116-j and seller 104-i. In other variations, order 122 includes explicitly the product, the seller, the buyer, fulfillment instructions (e.g., shipping address or pickup location), and the billing information. From order 122, clearinghouse 118 can track and record the buyer's shopping history 364 (FIG. 3) in database 320. Clearinghouse 118 can also track and record the aggregator's sales history 366 and the seller's sales history 368 in database 320. Clearinghouse 118 may require buyer 116-j to verify him or herself through his or her password when buyer 116-j places the order.

In action 707, clearinghouse 118 optionally queries aggregator 102 and receives the details of the order if buyer 116 j has provided transaction identifier 115 in action 706. As previously described in reference to method 600, aggregator 102 uses transaction identifier database 354 to store transaction identifiers and transaction details including the product number, the price, the business rules (including discounts), the seller, the buyer, the fulfillment method, the shipping address of the buyer, and the billing information of the buyer. Thus, aggregator 102 can used transaction identifier 115 to provide transaction details 150 to clearinghouse 118. In one implementation, clearinghouse 118 uses clearinghouse computer 318 to send transaction identifier 115 to aggregator computer 302 via network 306 in the normal manners. In these implementations, clearinghouse computer 318 also receives transaction details 150 of the order 122 from aggregator computer 302 via network 306 in the normal manners. Clearinghouse computer 318, e.g., holds transaction details 150 in memory 360 or database 320. Using transaction details 150, clearinghouse 118 can track and record the buyer's shopping history 364 (FIG. 3), the aggregator's sales history 366, and the seller's sales history 368 in database 320. In some variations, clearinghouse computer 318 and aggregator computer 302 communicate transaction details through customized or industry standard EDI (including XML). Alternatively, clearinghouse 118 could have a copy of transaction identifier database 354 locally received from aggregator 102 at an earlier time.

In action 708, clearinghouse 118 optionally determines if buyer 116j is a referral from another buyer. A buyer is a referral if that buyer receives catalog 114 from another buyer. For example, if buyer 116-j is a referral from buyer 116-n, clearinghouse 118 records the referral for buyers 116-j and/or 116-n in order to calculate their respective referral discount (or other forms of award), if any. Referral discount is provided to promote the distribution of catalog 114 to other buyers.

Clearinghouse computer 318 determines if buyer 116-j is a referral by verifying the identity of buyer 116-j against the identity of the buyer corresponding to the transaction identifier received from buyer 116-j. If the identity of buyer 116-j differs from the identity of the buyer corresponding to the transaction identifier, clearinghouse computer 318 assumes buyer 116j is a referral. Clearinghouse computer 318 determines the identity of buyer 116-j by verifying the password corresponding to the transaction identifier or by asking buyer 116j if he or she is the buyer corresponding to the transaction identifier.

Referral discount can be single or multi-tiered. In a single-tiered system, only the original recipient of catalog 114 (the buyer corresponding to the transaction identifiers in catalog 114) is awarded for the downstream distribution of catalog 114. In a multi-tiered system, any one in the distribution chain of catalog 114 can be awarded for the downstream distribution of catalog 114. In a multi-tiered system, clearinghouse computer 318 associates referral buyers with the transaction identifiers included in catalog 114. This association of referral buyers allows clearinghouse computer 318 to provide referral buyers with referral discounts when they further distribute catalog 114 to additional buyers that purchase from catalog 114. Again, referral discount is provided to promote the distribution of catalog 114 to other buyers.

In the multi-tiered system, clearinghouse computer 318 keeps a list of the referral buyers in buyer database 320. Clearinghouse computer 318 requests each referral buyer to identify the buyer that referred them to catalog 114 from the list of the referral buyers so that the referral discount is given to the appropriate parties. In one implementation, the list of referral buyers is maintained as a thread where the hierarchy of who referred who to catalog 114 is recorded. The threaded list of referral buyers can be used when the referral discount depends on the position of the referral buyer in the distribution chain of catalog 114.

In action 710, clearinghouse 118 optionally calculates the discount available to buyer 116-j from the business rules received from aggregator 102. In one implementation, clearinghouse 118 uses clearinghouse computer 318 to calculate the discounts. Sellers 104-1 to 104-m may provide various types of discounts to buyers 1161 to 116-n in their business rules. For example, seller 104-i may provide a discount to a first buyer for his or her next purchase if he or she refers a second buyer to catalog 114 and the second buyer purchases a product from catalog 114 and identifies the first buyer as his or her reference. Similarly, seller 104-i may provide a discount to the second buyer when he or she orders through catalog 114. These discounts provide incentives for the first buyer to distribute catalog 114 to the second buyer and the second buyer to purchase from catalog 114.

Sellers 104-1 to 104-m can also provide discount for past purchases by buyers 116-1 to 116-n. For example, clearinghouse 118 can keep track of the type and quantity of products 120 purchased by buyer 116-j and provide a discount for the next product 120 (or another product from the same or different seller in cross promotions) that buyer 116-j purchases when buyer 116-j has purchased a predetermined number of product 120 set by seller 104-i.

In action 712, clearinghouse 118 receives sales payment 124 for order 122 from buyer 116-j. In one implementation, clearinghouse 118 uses clearinghouse computer 318 to electronically transfer sales payment 124 ($A) from an account of buyer 116-j to an account of clearinghouse 118. In some variations, clearinghouse 118 reduces sales payment 124 according to the discount calculated in action 710.

In action 714, clearinghouse 118 determines if seller 104-i has retained the services of fulfiller 134-k to warehouse and deliver products to buyers 116-1 to 116-n. If so, action 714 is followed by action 716. Otherwise, action 714 is followed by action 718.

In action 716, clearinghouse 118 sends order 122 and shipping fees 136 to fulfiller 134-k. In one implementation, clearinghouse 118 uses clearinghouse computer 318 to electronically transfer shipping fees 136 ($D) to an account of fulfiller 134-k. If buyer 116-j has used transaction identifier 115 in order 122, clearinghouse 118 sends at least a portion of transaction details 150 to fulfiller 134-k so fulfiller 134-k can fulfill order 122. In some variations, clearinghouse computer 318 and fulfiller computer 334 communicate order 122 and transaction details 150 through customized or industry standard EDI (including XML).

Alternatively, clearinghouse 118 can send order 122 to seller 104-i and then seller 104-i can forward order 122 (or transaction details 150) to fulfiller 134-k. Similarly, clearinghouse 118 can send both shipping fees 136 and sales proceeds 130 to seller 104-i and seller 104-i can forward shipping fees 136 to fulfiller 134-k.

In action 717, clearinghouse 118 optionally receives fulfillment status report 138 (FIG. 2) from fulfiller 134-k because in one implementation clearinghouse 118 only pays the seller once the seller ships the ordered product. In some variations, clearinghouse computer 318 receives fulfillment status report 138 from fulfiller computer 334 via network 306 in the normal manners. In some variations, clearinghouse computer 318 and fulfiller computer 334 communicate fulfillment status report 138 through customized or industry standard EDI (including XML). Action 717 is followed by action 720.

In action 718, clearinghouse 118 sends order 122 to seller 104-i. In one implementation, clearinghouse 118 uses clearinghouse computer 318 to send order 122 to seller computer 304 via network 306 in the normal manners. If buyer 116-j has used transaction identifier 115 in order 122, clearinghouse 118 sends at least a portion of transaction details 150 to fulfiller 134-k so fulfiller 134-k can fulfill order 122. In some variations, clearinghouse computer 318 and seller computer 304 communicate order 122 and transaction details 150 through customized or industry standard EDI (including XML).

In action 719, clearinghouse 118 optionally receives a fulfillment status report 132 (FIG. 1) from seller 104-i because in one implementation clearinghouse 118 only pays the seller once the seller has shipped the ordered product. In some variations, clearinghouse computer 318 receives fulfillment status report 132 from seller computer 304 via network 306 in the normal manners. In some variations, clearinghouse computer 318 and seller computer 304 communicate fulfillment status report 132 through customized or industry standard EDI (including XML). Action 719 corresponds to action 424 of method 400. Action 719 is followed by action 720.

In action 720, clearinghouse 118 sends sales proceeds 130 to seller 104-i. In one implementation, clearinghouse 118 uses clearinghouse computer 318 to electronically transfer sales proceeds 130 from sales payment 124 received from buyer 116-j to an account of seller 104-i. Action 720 corresponds to action 418 of method 400.

In action 722, clearinghouse 118 sends marketing fees 128 to aggregator 102. In one implementation, clearinghouse 118 uses clearinghouse computer 318 to electronically transfer marketing fees 128 from sales payment 124 received from buyer 116-j to an account of aggregator 102. Action 722 corresponds to action 522 of method 500. In another implementation, some or all of the aggregators that are in the distribution chain recorded in business rule 112 for product 120 are compensated by clearinghouse 118. The aggregators can by paid by various schemes specified by seller 104-i (e.g., single or multi-tiered).

In action 724, clearinghouse 118 handles any customer returns and complaints from buyer 116-j. Depending on the implementation, clearinghouse 118 informs either seller 104-i or fulfiller 134-k that buyer 116-j wishes to return product 120. Depending on the return policy of seller 104-i, seller 104-i either accepts the return and give buyer 116-j a refund (whether cash or store credit), or exchanges the return for another product.

In one embodiment, clearinghouse 118 tracks histories of the purchases and sales of the buyers, the sellers, and the aggregator through which the items are sold. All these information are available to clearinghouse 118 because it is the intermediary between all the parties. Depending on the implementation, clearinghouse 118 can record these histories for analysis or safekeeping. For example, clearinghouse 118 can keep buyer's shopping history in confidence to satisfy the privacy concerns of the buyers. Clearinghouse 118 can provide the aggregator's selling history to the sellers for evaluation. Similarly, when the sellers is not the manufacturer, clearinghouse 118 can provide the seller's selling history to the manufacture for evaluation. Such information can be provided anonymously (in the form of statistics) for use, e.g., in marketing projections.

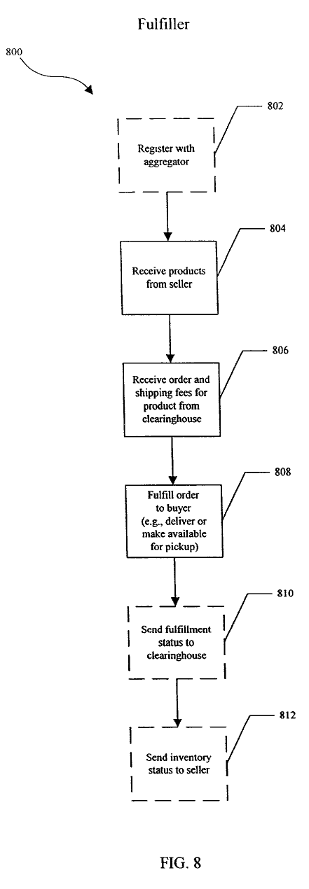

Method 800 (FIG. 8) illustrates the actions of fulfiller 134-k in one embodiment. In one implementation, fulfiller 134-k uses fulfiller computer 334 (FIG. 3) to transact with seller computer 304, aggregator computer 302, and aggregator computer 302 via network 306. Communication over network 306 can occur through land lines or wireless connections.

In action 802, fulfiller 134-k optionally registers with aggregator 102. In one implementation, fulfiller 134-k uses fulfiller computer 334 to send fulfiller registration information via web forms to aggregator computer 302 over network 306 in the normal manners. Fulfiller registration information includes the fulfiller's contact information (e.g., address and telephone number), billing information (e.g., bank account number), and methods by which orders can be submitted to the fulfiller (e.g., order telephone line, order address line, order web address, order email address, and electronic data interchange (EDI) information). In another implementation, if fulfiller 134-k does not register with aggregator in action 102, seller 104-i includes fulfiller registration information in product package 108 that seller 104-i sends to aggregator computer 302 via network 306.

Fulfiller 134-k can also register with clearinghouse 118 by sending fulfiller registration information 370 (FIG. 3) to clearinghouse computer 318. Clearinghouse computer 318 saves fulfiller register information 370 in database 320. Clearinghouse 118 can use fulfiller registration information 370 to determine how to pay and send orders to fulfiller 134-k. Alternatively, seller 104-I can provide fulfiller registration information 370 to clearinghouse 118 as part of seller registration information 146.

In action 804, fulfiller 134-k receives products from sellers 104-i and maintains an inventory of the products in a storage facility such as a warehouse or a retail store. In action 806, fulfiller 134-k receives order 122 (or transaction details 150) and shipping fees 136 from clearinghouse 118. In one implementation, fulfiller 134-k uses fulfiller computer 334 to receive order 122 (or transaction details 150) from clearinghouse computer 318 via network 306 in the normal manners.

Alternatively, fulfiller 134-k can receive shipping fees 136 from seller 104-i if seller 104-i received shipping fees 136 from clearinghouse 118. Similarly, fulfiller 134-k can receive order 122 (or transaction details 150) from seller 104-i if seller 104-i received order 122 (or transaction details 150) from clearinghouse 118. Action 806 corresponds to action 716 of FIG. 7.

In action 808, fulfiller 134-k fulfils order 122 for buyer 116-j. Depending on order 122, fulfiller 134-k may deliver product 120 to the shipping address specified in order 122 or make product 120 available for pickup by buyer 116-j at a predetermined location such as a warehouse or a retail store. Depending on the implementation, fulfiller 134-k may deliver product 120 itself or use a common carrier to deliver product 120. In one variation, fulfiller 134-k sends product 120 (e.g., electronic content including music, books, and movies) to buyer 116-j over network 306. In another variation where product 120 (e.g., electronic content) and catalog 114 are stored on a computer readable medium(e.g., digital versatile disk), fulfiller 134-k sends a key that allows access to product 120 on the computer readable medium to buyer 116-j over network 306.

In action 810, fulfiller 134-k optionally sends fulfillment status report 138 of order 122 to clearinghouse 118. In one implementation, fulfiller 134-k uses fulfiller computer 334 to send fulfillment status report 138 to clearinghouse computer 318 in the normal manners. Action 810 corresponds to action 717 of FIG. 7.

In action 812, fulfiller 134-k optionally sends inventory status report 140 to seller 104-j. In one implementation, fulfiller 134-k uses fulfiller computer 334 to send inventory status report 140 to seller computer 304 in the normal manners. Action 812 corresponds to action 416 of method 400. Although only a single fulfiller computer 334 is shown, one skilled in the art understands that multiple fulfiller computers can be used by fulfillers 134-1 to 134-o as described in method 800.

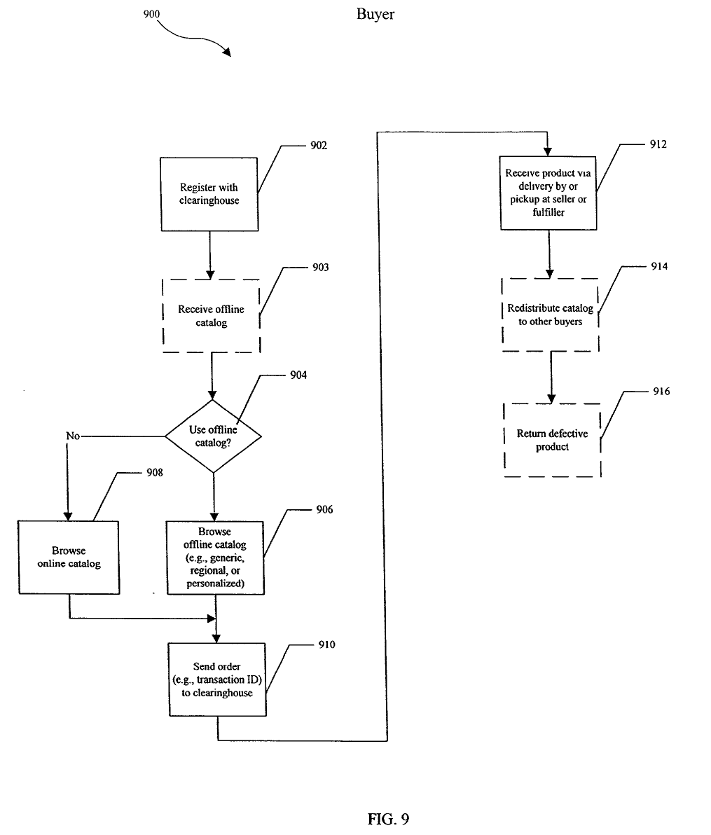

Method 900 (FIG. 9) illustrates the actions of buyer 116-j in one embodiment. In one implementation, buyer 116-j uses buyer computer 316 (FIG. 3) to transact with clearinghouse computer 318 over network 306. Buyer computer 316 includes personal computers (PCs), cellular phones and personal digital assistants (PDAs). Communication over network 306 can occur through land lines or wireless connections.

In action 902, buyer 116-j registers with clearinghouse 118. In one implementation, buyer 116-j uses buyer computer 316 to send buyer registration information 126 via web forms to clearinghouse computer 318 over network 306 in the normal manners. In another implementation, buyer 116-j can register with a service representative of clearinghouse 118 via the telephone or the mail. Action 902 corresponds to action 702 of method 700.

In action 903, buyer 116j optionally receives an offline catalog 114. Offline catalog 114 includes paper catalogs and electronic catalogs saved on a computer readable medium. In one implementation, buyer 116-j uses buyer computer 316 to download offline catalog 114 from aggregator computer 302 in the normal manners. In another implementation, buyer 116-j receives offline catalog 114 via delivery by a common carrier or by a fulfiller 134-k.

In action 904, buyer 116-j determines if he or she wants to use an offline catalog 114 (e.g., a paper catalog or an electronic catalog saved on a computer readable medium). If so, action 904 is followed by action 906. Otherwise, action 904 is followed by action 908.

In action 906, buyer 116-j browses offline catalog 114. In one implementation, catalog 114 is in HTML format and buyer uses a conventional browser on buyer computer 316 to view products in catalog 114. In another implementation, catalog 114 is in PDF format and buyer uses a conventional viewer on buyer computer 316 to view products in catalog 114. Conventional viewers include Adobe Acrobat. In yet another implementation, a catalog program can be written to view products in catalog 114 saved in any of multiple formats. The catalog program may include features such as keyword search and product comparison where products of same product category are graphically displayed on a monitor of buyer computer 316 for comparison. The catalog program can also allow free preview of any products (e.g., electronic content including music, books, and movies) stored along with catalog 114 on the computer readable medium. Action 906 is followed by action 910.

In action 908, buyer 116j browses online catalog 114. In one implementation, online catalog 114 is in HTML format and buyer uses a conventional browser on buyer computer 316 to view products in online catalog 114 stored on aggregator computer 302 via network 306.

In action 910, buyer 116-j sends order 122 to clearinghouse 118. In one implementation, buyer 116-j uses buyer computer 316 to send order 122 to clearinghouse computer 318 over network 306 in the normal manners. As described above, buyer 116-j can send transaction identifier 115 in order 122 to identify a sales transaction between buyer 116-j and seller 104-i. Alternatively, buyer 116-j submits order 122 via a service representative of clearinghouse 118 over the telephone or the mail to explicitly identify the product, the seller, the buyer, fulfillment instructions (e.g., shipping address or pickup location), and the billing information. Action 910 is further described in related U.S. patent application Ser. No. ______, entitled “E-COMMERCE USING AN IDENTIFIER”, inventors Tam et al., filed ______, attorney docket number M-9127 US.

In action 912, buyer 116-j receives product 120. Depending on the implementation, buyer 116-j receives product 120 by delivery from either seller 104-i or fulfiller 134-k, or by pickup of product 120 at a predetermined location (e.g., a storage facility such as a warehouse or a retail store) of seller 104-i or fulfiller 134-k. In one variation, buyer 116-j receives product 120 over network 306 if product 120 includes electronic content (e.g., music, books, and movies). In another variation where product 120 and catalog 114 are both stored on a computer readable medium distributed to buyer 116-j, buyer 116-j receives a key for accessing product 120 from the computer readable medium from fulfiller 134-k over network 306.

In action 914, buyer 116-j optionally redistributes catalog 114 to other buyers. For example, buyer 116-j optionally sends catalog 114 to buyer 116-n. As described above in one implementation, buyer 116-j receives discounts in his or her next purchase if buyer 116-n orders a product from catalog 114. Thus, buyer 116-j has an incentive to refer catalog 114 to other buyers. As described above in some variations, buyer 116-n also receives a discount when he or she orders from catalog 114 received from buyer 116j. Thus, buyer 116-n has financial incentive to use catalog 114 referred by buyer 116-j.

In action 916, buyer 116-j optionally returns product 120. In one implementation, buyer 116-j informs clearinghouse 118 that he or she wishes to return product 120. Clearinghouse 118 handles the return on behalf of seller 104-i and/or fulfiller 134-k according to a predetermined arrangement. Action 916 corresponds to action 716 of FIG. 7. Although only a single buyer computer 316 is shown, one skilled in the art understands that multiple buyer computers can be used by buyers 116-1 to 116-n as described in method 900.

Although the invention has been described with reference to particular embodiments, the description is only of examples and should not be taken as a limitation. For example, the functions of aggregator 102 and clearinghouse 118 can be accomplished by a single entity. Also, an aggregator 102 may not distribute a catalog to buyers, instead may distribute just pointers (such as URLs) to the information and business rules at each identified seller's website. In this embodiment, the sellers do not actually send the information and business rules to the aggregator, and instead send their individual pointers. Although only one clearinghouse is shown in FIGS. 1 and 2, systems 100 and 200 can both include multiple clearinghouses for receiving orders and payment instructions from buyers.

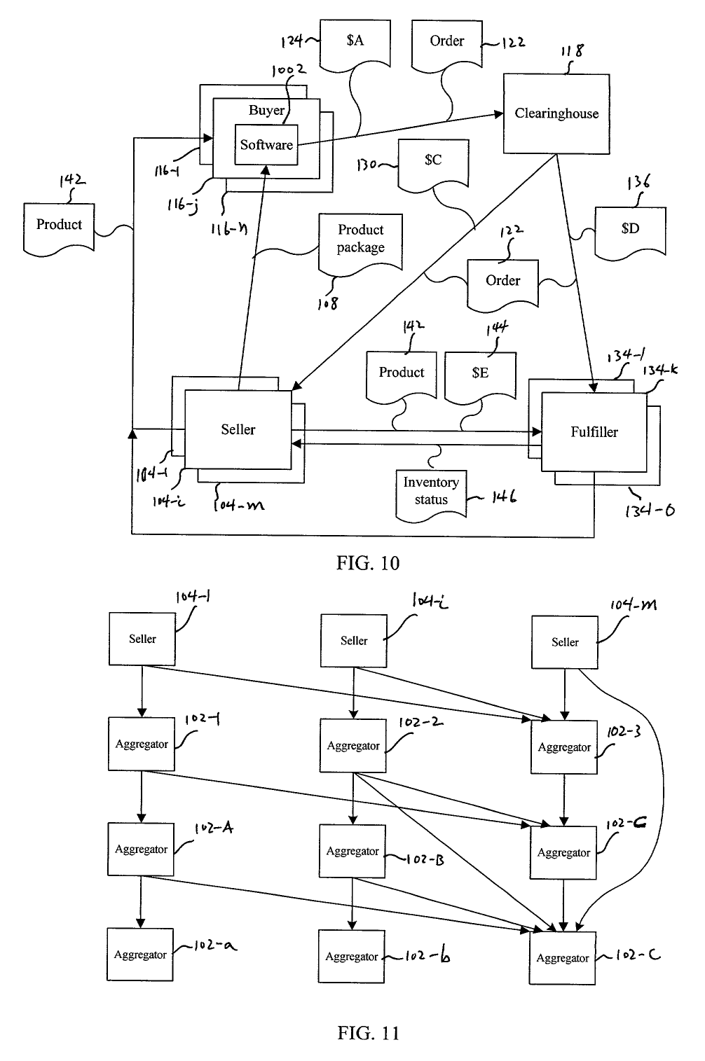

As illustrated in FIG. 10, the functions of an aggregator 102 may be eliminated, e.g. if the sellers 104-1 to 104-m submit their product packages 108 directly to buyers 116-1 to 116-n. Buyers 116-1 to 116-n each has a software 1002 that compiles product packages 108 into a catalog. Buyers 116-1 to 116-n send their orders 122 and payment instructions 124 to clearinghouse 118 as described above.

As illustrated in FIG. 11, sellers can submit their product packages to various aggregators. For example, seller 104-1 submits its product packages to aggregators 102-1, 102-2, and 102-3. Aggregators can submit product packages to each other to include the items in those product packages in additional catalogs generated by other aggregators. For example, aggregators 102-1 to 102-3 submit their product packages to aggregator 102-C. Sellers and aggregators can submit product packages to another aggregator. For example, seller 104-m and aggregators 102-A, 102-B, and 102-C submit their product packages to aggregator 102-c.

In addition, although XML has been identified as one form of EDI, other formats of EDI may also be used to communicate data between the aggregator 102, sellers 104-1 to 104-m, clearinghouse 118, buyers 116-1 to 116-n, and fulfillers 134-1 to 134-o. Furthermore, multiple types of medium (e.g., phone, wireless, and network) may be employed to communicate data between the aggregator 102, sellers 104-1 to 104-m, clearinghouse 118, buyers 116-1 to 116-n, and fulfillers 134-1 to 134-o. Moreover, depending on the embodiment, instead of a catalog (as described above), any other structure (such as a directory listing) for holding multiple offers can be used, as described herein. Various other adaptations and combinations of features of the embodiments disclosed are encompassed by the following claims.

We claim:

1. A method for selling, comprising:
a first party (“aggregator”) receiving from a second party (“seller”) information on a product or service (“item”) for sale;
the aggregator preparing a catalog that comprises a plurality of listings of said item offered for sale by a corresponding plurality of sellers including said seller;
the aggregator sending the catalog to a third party (“buyer”);
a fourth party (“clearinghouse”) receiving from said buyer an order for purchase of said item and a payment instruction for said order; and
the clearinghouse paying at least one of the aggregator and the seller.

2. The method of claim 1, wherein the information from the seller includes an identification of the item, a price, and a description.

3. The method of claim 2, wherein the information further includes at least one of a fulfillment method and a discount.

4. The method of claim 1, further comprising the clearinghouse sending to the seller information about the order.

5. The method of claim 4, wherein the order includes an identification of the item and a shipping address of the buyer.

6. The method of claim 4, further comprising the seller sending to the buyer the item.

7. The method of claim 1, wherein said act of receiving from said buyer a payment instruction comprises:
the clearinghouse receiving the billing information of the buyer to be used for payment for said order;
wherein the clearinghouse does not send said billing information to the aggregator and the seller.

8. The method of claim 7, wherein:
the clearinghouse receives said billing information during a registration process prior to receiving said order; and
the clearinghouse receives authorization by the buyer to use said billing information on placing said order.

9. The method of claim 6, further comprising:
the clearinghouse receiving from the seller a notification that the seller has sent the product to the buyer; and
the clearinghouse paying the seller on receipt of said notification.

10. The method of claim 1, further comprising the aggregator receiving from the seller registration information.

11. The method of claim 10, wherein the registration information includes at least one of a name, a telephone number, a mail address, a computer network address, billing information, and electronic data interchange information.

12. The method of claim 1, further comprising the seller sending to a fifth party (“fulfiller”) the item, the fulfiller storing the item.

13. The method of claim 12, further comprising the clearinghouse sending to the fulfiller a fulfillment instruction for the buyer.

14. The method of claim 13, further comprising the seller receiving from the fulfiller a notification of an inventory of the item.

15. The method of claim 2, wherein the information further includes at least one of an image and a category.

16. The method of claim 1, wherein the catalog is hereafter the “first catalog”, the method further comprising:
the aggregator (hereafter “first aggregator”) sending said information to a fifth party (“second aggregator”); and
the second aggregator preparing a second catalog that comprises another plurality of listings of said item offered for sale by another corresponding plurality of sellers including said seller.

17. The method of claim 16, wherein the buyer is hereafter the “first buyer”, the method further comprising the second aggregator sending the second catalog to a sixth party (“second buyer”).

18. The method of claim 17, further comprising:
the clearinghouse receiving from said second buyer a payment instruction and an order; and
the second clearinghouse paying at least one of the first aggregator, the second aggregator, and the seller.

19. The method of claim 17, wherein the clearinghouse is hereafter the “first clearinghouse”, the method further comprising:
a seventh party (“second clearinghouse”) receiving from said second buyer a payment instruction and an order; and
the second clearinghouse sending a payment to at least one of the first aggregator, the second aggregator, and the seller.

20. The method of claim 19, further comprising:
the second clearinghouse sending to the seller information about the order; and
the seller sending to the second buyer the item.

21. The method of claim 20, further comprising:
the seller sending to an eighth party (“fulfiller”) the item, the fulfiller storing the item; and
the second clearinghouse sending to the fulfiller a fulfillment instruction for the second buyer.

22. The method of claim 1, wherein the information on the item includes identification of said sellers and said seller makes or provides the item.

23. The method of claim 1, wherein the seller is hereafter the “first seller”, the method further comprising the aggregator receiving from a fifth party (“second seller”) information on the item, wherein said sellers include the second seller.

24. The method of claim 1, further comprising the aggregator receiving information on the buyer.

25. The method of claim 24, wherein the information on the buyer includes at least one of a name, an address, billing information, an interest, an age, an income level, and other characteristics used to profile the buyer for marketing purposes.

26. The method of claim 24, wherein said act of preparing the catalog comprises the aggregator customizing the content of the catalog in accordance to the information on the buyer.

27. The method of claim 24 wherein said act of preparing the catalog comprises the aggregator customizing the content of the catalog in accordance to the area where the first aggregator distributes the catalog.

28. The method of claim 1, wherein said act of preparing the catalog comprises the aggregator including a string of characters that identifies a sales transaction of the item that can happen between one of the seller and the buyer in the catalog.

29. The method of claim 28, wherein the string of characters can be related to transaction details including identifications of the buyer, one of the sellers, the item, and a fulfillment method.

30. The method of claim 28, further comprising:
the clearinghouse receiving the string of characters from the buyer;
the clearinghouse sending the string of characters to the aggregator; and
the aggregator sending transaction details to the clearinghouse.

31. The method of claim 1, wherein said act of preparing the catalog includes one of:
(a) printing on paper so that said catalog is a paper catalog;
(b) transferring said information through a computer network so that said catalog is an online catalog; and
(c) storing said information on a computer readable medium so that said catalog is an electronic catalog.

32. The method of claim 1, wherein the clearinghouse pays only the aggregator and the aggregator pays the seller.

33. The method of claim 32, wherein the aggregator pays a majority of the payment from the clearinghouse to the seller.

34. The method of claim 1, wherein the clearinghouse pays only the seller and the seller pays the aggregator.

35. The method of claim 34, wherein the seller pays the aggregator a fixed payment.

36. The method of claim 35, wherein the seller pays the aggregator a percentage of the sale price of the item.

37. A method for selling, comprising:
a first party (“clearinghouse”) receiving from a second party (“buyer”) billing information of the buyer; and
the clearinghouse receiving from the buyer an order for a product or service (“item”) from a catalog generated by a third party (“aggregator”);
the clearinghouse sending the order to a fourth party (“fulfiller”) that fulfills the order, wherein the method is devoid of the clearinghouse and the buyer sending the billing information of the buyer to either the aggregator and the fulfiller.

38. The method of claim 37, further comprising:
the aggregator determining if the buyer qualifies for a discount; and
the aggregator providing the discount to the order.

39. The method of claim 38, wherein said determining comprises detecting whether or not the buyer has previously purchased a predetermined number of the item or another item.

40. The method of claim 38, wherein said determining comprises detecting whether or not a fifth party (“second buyer”) has referred the buyer (hereafter “first buyer”) to shop from the catalog.

41. The method of claim 38, wherein said determining comprises detecting whether or not the buyer (hereafter “first buyer”) has referred a fifth party (“second buyer”) to shop from the catalog.

42. A method for selling, comprising:
a first party (“fulfiller”) storing a product for a second party (“seller”) that sells or makes the product;
the fulfiller receiving from a third party (“clearinghouse”) an order for the product by a fourth party (“buyer”);
the fulfiller sending the product to the buyer;
the fulfiller receiving from the clearinghouse a payment for sending the product to the buyer; and
the seller receiving from one of the clearinghouse and the fulfiller payment for sale of the product.

43. The method of claim 42, further comprising the fulfiller receiving from the seller a payment for storing the product.

44. The method of claim 42, wherein the order for the product includes the identity of the product and a shipping address of the buyer.

45. The method of claim 42, further comprising the fulfiller sending to the clearinghouse a notification that the fulfiller has sent the product to the buyer prior to the fulfiller receiving from the payment.

46. The method of claim 42, further comprising the fulfiller sending to the seller a notification of an inventory of the product.

47. A method of selling, the method comprising:
supplying to a buyer a description of a plurality of items available for sale; and
receiving from a party other than the buyer information derived from sale to the buyer of an item in the plurality.

48. The method of claim 47, wherein said party is a fulfiller, the information includes the number of items delivered by the fulfiller per unit time and the method comprises a seller supplying said number of items to the fulfiller.

49. The method of claim 47, wherein said party is a financial clearinghouse, the method further comprises receiving payment for the sale from said party, and said method is performed by an aggregator or by a seller.

50. The method of claim 47, wherein said party is a financial clearinghouse, the information consists essentially of financial information related to the sale, but not the identity of buyer.

51. A method for selling an item, comprising:
receiving a plurality of information about the item from a plurality of sellers;
receiving the item from at least one of the sellers;
generating a catalog from the plurality of information;
storing the catalog and the item on a computer readable medium; and
distributing the computer readable medium to a plurality of buyers.

52. A method for selling an item, comprising:
sending the item and information about the item to a first party, wherein the first party generates a catalog from the information, stores the item and the catalog on a computer readable medium, and distributes the computer readable medium to a second party;
receiving payment from a third party for a purchase of the item by the second party; and
sending a key to access the item on the computer readable medium to the second party.

53. A storage medium encoded with:
a first history of purchases of a buyer; and
a second history of sales by a seller;
wherein the first history includes the purchase of an item from said seller and the second history includes the sale of the item to said buyer.

54. The storage medium of claim 53, further encoded with a third history, wherein the third history includes purchases of items by a plurality of buyers including said buyer and sales of items by sellers including said seller.

55. The storage medium of claim 53, further encoded with one or more of: buyer's name, address, credit card number, interests, age, income level, and password.

56. The storage medium of claim 53, further encoded with one or more of seller's address, telephone number, bank account number, order telephone line, order address line, order web address, order email address, and electronic data interchange (EDI) information.

57. The storage medium of claim 53, further encoded with information of a fulfiller used by the buyer to delivery the item, the information including one or more of fulfiller's address, telephone number, bank account number, order telephone line, order address line, order web address, order email address, and electronic data interchange (EDI) information.

58. The storage medium of claim 53, further encoded with a delivery status of the item.

59. A method for selling, comprising:
a first party (“first aggregator”) receiving from a first plurality of parties (“first sellers”) information on a product or service (“item”) for sale;
the first aggregator sending the information to a second party (“second aggregator”);
the second aggregator preparing a catalog that comprises a plurality of listings of said item offered for sale by a corresponding second plurality of parties (“second sellers”) including said first sellers;
the second aggregator sending the catalog to a third party (“buyer”); and
a fourth party (“clearinghouse”) receiving from said buyer a payment instruction and an order.

60. The method of claim 59, further comprising the clearinghouse sending a payment to at least one of (1) the first aggregator, (2) the second aggregator, (3) one of the first sellers, and (4) one the second sellers.

61. The method of claim 54, further comprising a third aggregator receiving information from the first aggregator and the second aggregator and distributing another catalog containing at least a portion of said information to another buyer.

62. A method for selling, comprising:
a plurality of first parties (“sellers”) sending to a second party (“buyer”) information on a product or service (“item”) for sale;
a third party (“clearinghouse”) receiving from the buyer a payment instruction and an order;
the clearinghouse sending the order to one of the sellers; and
the clearinghouse paying said one of the sellers.

63. A system for selling items, comprising:
a first computer containing information on a plurality of items for sale from a corresponding plurality of sellers;
a second computer coupled to the first computer, the second computer containing an order for purchase of one of said items and a payment instruction for the order; and
a third computer being coupled to the first computer and the second computer, the third computer containing a plurality of orders including said order and payment instructions including said payment instruction.
